(19) United States
(12) Patent Application Publication
(10) Pub. No.: US 2025/0076106 A1
(43) Pub. Date: Mar. 6, 2025

(54) FASTENER DRIVING OPERATION RESULT DETECTOR

(71) Applicant: BotBuilt, Inc., Durham, NC (US)

(72) Inventor: Christopher Barrett Ames, Durham, NC (US)

(21) Appl. No.: 18/825,921

(22) Filed: Sep. 5, 2024

Related U.S. Application Data
(60) Provisional application No. 63/580,616, filed on Sep. 5, 2023.

(51) Int. Cl. G01H 17/00; B27F 7/00

(52) U.S. Cl. CPC G01H 17/00; B27F 7/00

(57) ABSTRACT

Systems and methods for a fastener driving system are disclosed. The system includes a fastener driving tool configured to drive a fastener through a covering material and into an underlying framing member, where the fastener tool generates sound upon driving the fastener through the covering material. The system includes an acoustic transducer configured to capture the sound generated by the fastener driving tool. The system includes processing circuitry configured to analyze a frequency spectrum of the audio to generate a frequency spectrum analysis, based on the frequency spectrum analysis, determine whether the fastener hit or missed the underlying framing member, and generate an indication of the determination.

### CROSS-REFERENCE TO RELATED APPLICATIONS

The present application claims the benefit of and priority to U.S. Provisional Application No. 63/580,616, entitled “Fastener Driving Operation Result Detector,” and filed on Sep. 5, 2023, each of which is herein incorporated by reference in its entirety.

### TECHNICAL FIELD

The present disclosure generally relates to systems and methods for improving fastening tools, and in particular to systems and methods of automatically determining the success of a fastening operation.

### BACKGROUND

Residential home and/or industrial building construction can often be dependent on slow, inefficient, rigid, expensive and manual conventional construction techniques. Some fundamental operations used in construction a residential home and/or industrial building can be imprecise. Specifically, users of powered fastener driver tools rely on manual approximation to determine that a fastening operation successfully fastened a workpiece to a targeted stud, joist, or other framing member. Furthermore, the user is left to estimate where the fastener had been placed, without any feedback where the fastener was located.

The foregoing discussion, including the description of motivations for some embodiments of the invention, is intended to assist the reader in understanding the present disclosure, is not admitted to be prior art, and does not in any way limit the scope of any of the claims.

### SUMMARY

Systems and methods for a fastener driving operation detection are disclosed. In some embodiments, the system can include an sound transducer, such as a microphone, and that can capture sound generated by a fastener driving operation. The sound, e.g., represented by a captured audio signal, can be converted from a time domain to a frequency domain, and the spectrum of the sound can be analyzed to determine whether a driven fastener hit or missed an underlying framing member. A result of the fastener driving operation can be determined based a comparison the magnitude of the captured audio signal in the predetermined frequency ranges to defined thresholds. Thresholds can be defined for the predetermined frequency ranges. Furthermore, the thresholds can be updated and/or revised during a calibration procedure.

In some embodiments, a machine learning (ML) model can be trained to determine the result of a fastener driving operation based on audio spectra, and/or the ML model used to determine the result of the fastener driving operation. The system can output a signal indicative of the result of the fastener driving operation, e.g., such as illuminating a red or green LED, and/or transmitting a wireless signal to an application running on a host device. The system can be configured for ruggedized specifications, and/or can be incorporated into a fastener driving tool. In some examples, the system can be a discrete device, e.g., the device can provide the results for fastener driving operations for a plurality of fastener driving tools. The discrete device can also be operative to perform fastener driving operation result detection on other fastener driving tools, e.g., legacy fastener driving tools, among other tools.

In some embodiments, the system can include a housing and a sensor including at least one of an acoustic transducer or an accelerometer, wherein the acoustic transducer is configured to capture sound generated by operation of a fastener driving tool attempting to drive a fastener through a covering material and into an underlying framing member. The system can include processing circuitry. The processing circuitry can be configured to generate an audio signal based on the captured sound. The processing circuity can be configured to analyze a frequency spectrum of the audio signal to generate a frequency spectrum analysis. Based on the frequency spectrum analysis, the system can be configured to determine whether the driven fastener hit or missed the underlying framing member. The system can be configured to generate an indication of the determination whether the system hit or missed the underlying framing member.

Various embodiments of the system can include one or more of the following features.

In some embodiments, the system can include outputs configured to convey a fastener driving operation result detection to a user based on the determination. In some examples, the outputs can include visual indicators, e.g., such as LEDs. In some examples, the acoustic transducer can include a microphone. Analyzing the frequency spectrum can include transforming the audio signal to an audio signal having a frequency domain representation, and analyzing the frequency domain representation of the audio signal. Analyzing the frequency domain representation of the audio signal can include comparing a magnitude of the audio signal to a first predetermined threshold associated with a first frequency range, and determining a result of the fastener operation based on whether the magnitude of the audio signal exceeds the first threshold within the first frequency range. Analyzing the frequency domain representation of the audio signal can include comparing the magnitude of the audio signal to a second predetermined threshold associated with a second frequency range, and verifying the determined result of the fastener operation based on whether the magnitude of the audio signal exceeds the second threshold within the second frequency range. Analyzing the frequency domain representation of the audio signal can include processing the audio signal with a Machine Learning (ML) model, where the ML was trained to distinguish the audio fastener driving operations that hit and underlying framing member from the audio of the fastener driving operations that miss the underlying framing member.

A method of determining a result of a fastener driving operation is presented. The method can include capturing sound based on the operation of a fastener driving tool attempting to drive a fastener through a covering material and into an underlying framing member. The method can include generating an audio signal based on the captured sound. The method can include analyzing at least a portion of a frequency spectrum of the audio signal to generate a frequency spectrum analysis. Based on the frequency spectrum analysis, the method can include determining whether the driven fastener hit or missed the underlying framing member. The method can include generating an indication of the determination. Generating the indication of the determination can include generating a result of the fastener driving operation based on the frequency spectrum analysis.

Various embodiments of the method can include one or more of the following steps.

In some embodiments, the method can include outputting the indication of the determination to a user. In some examples, the method can include transmitting the indication of the determination to a robotic control system. Analyzing at least a portion of a frequency spectrum can include transforming the audio signal to a frequency domain, and analyzing the frequency domain representation of the audio signal. Analyzing at least a portion of a frequency spectrum can include comparing a magnitude of captured audio to a first predetermined threshold associated with a first frequency range, and determining a result of the fastener operation to be the hit or miss associated with the first frequency range if the magnitude of captured audio signal exceeds the first threshold within the first frequency range. Analyzing at least a portion of a frequency spectrum can include comparing a magnitude of audio signal to a second predetermined threshold associated with a second frequency range, and verifying the determined result of the fastener operation if the magnitude of audio signal exceeds the second threshold within the second frequency range. Analyzing at least a portion of a frequency spectrum can include processing the audio signal with a Machine Learning (ML) model, wherein the ML model was trained to distinguish the audio of fastener driving operations that hit an underlying framing member from the audio of fastener driving operations that miss the underlying framing member.

A computer implemented method for determining a result of a fastener driving operation is presented. The method can include capturing sound generated by operation of a fastener driving tool attempting to drive a fastener through a covering material and into an underlying framing member. The method can include generating an audio signal based on the captured sound. The method can include comparing at least a portion of a frequency spectrum of the audio signal to a stored threshold frequency. The method can include, based on the frequency spectrum comparison, determining whether the driven fastener hit or missed the underlying framing member. The method can include generating an indication of the determination.

Various embodiments of the method can include one or more of the following steps.

The method can include outputting the indication of the determination to a user. The method can include transmitting the indication of the determination to a robotic control system. In some examples, comparing at least a portion of a frequency spectrum of the audio signal can include transforming the audio signal to a frequency domain, and analyzing the frequency domain representation of the captured audio. In some examples, comparing the frequency domain representation of the audio signal can include comparing a magnitude of audio signal to the stored threshold frequency associated with a first frequency range.

As described herein, in some embodiments, the audio signal can also be referred to as a captured audio, and/or a captured audio signal.

### BRIEF DESCRIPTION OF THE DRA WINGS

The accompanying figures, which are included as part of the present specification, illustrate the presently preferred embodiments and together with the generally description given above and the detailed description of the preferred embodiments given below serve to explain and teach the principles described herein.

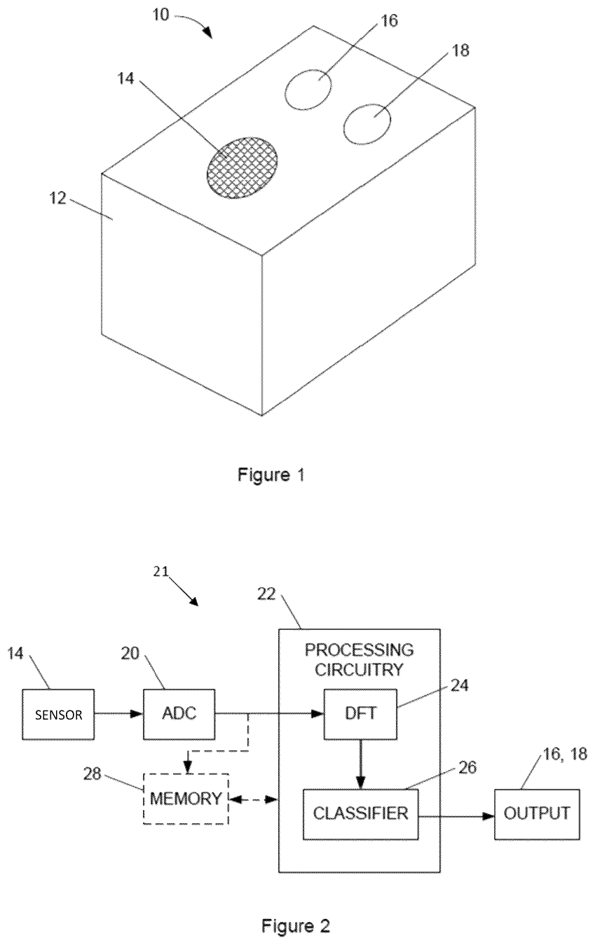

FIG. 1 illustrates a perspective view of a fastener driving operation detection system, according to some embodiments.

FIG. 2 illustrates a block diagram of electronic circuits of the fastener driving operation detection system, according to some embodiments.

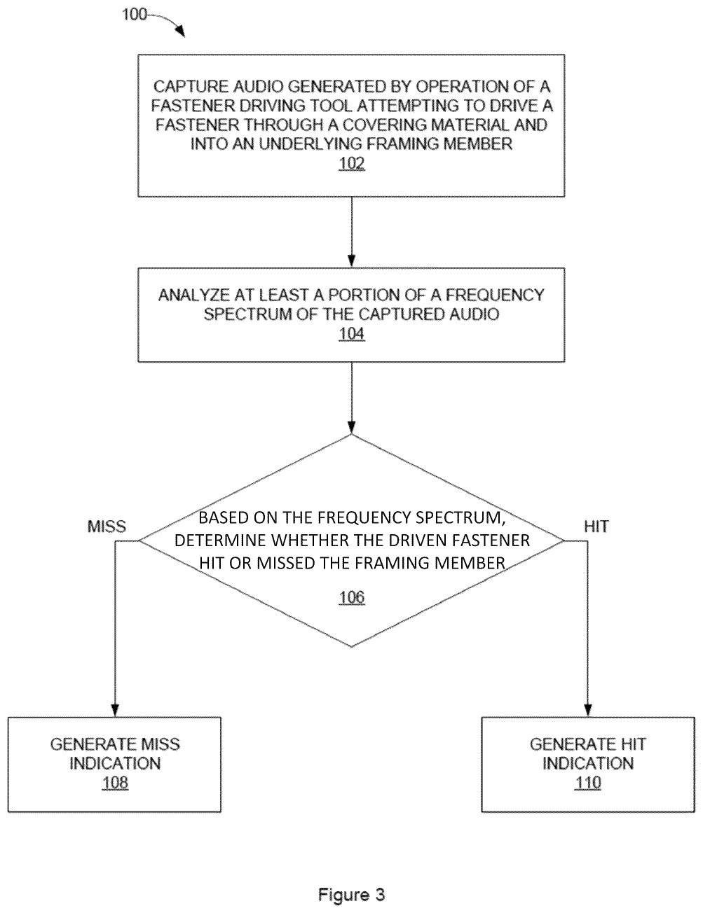

FIG. 3 illustrates a flowchart of a method of determining a result of a fastener driving operation, according to some embodiments.

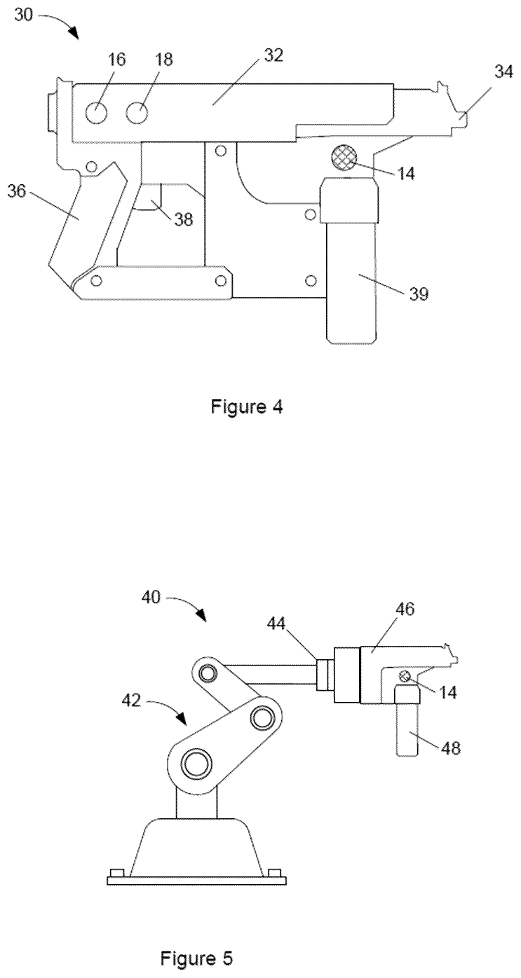

FIG. 4 illustrates a nail-driving tool incorporating a fastener driving operation detection system, according to some embodiments.

FIG. 5 illustrates a robotic nail-driving tool incorporating a fastener driving operation detection system, to some embodiments.

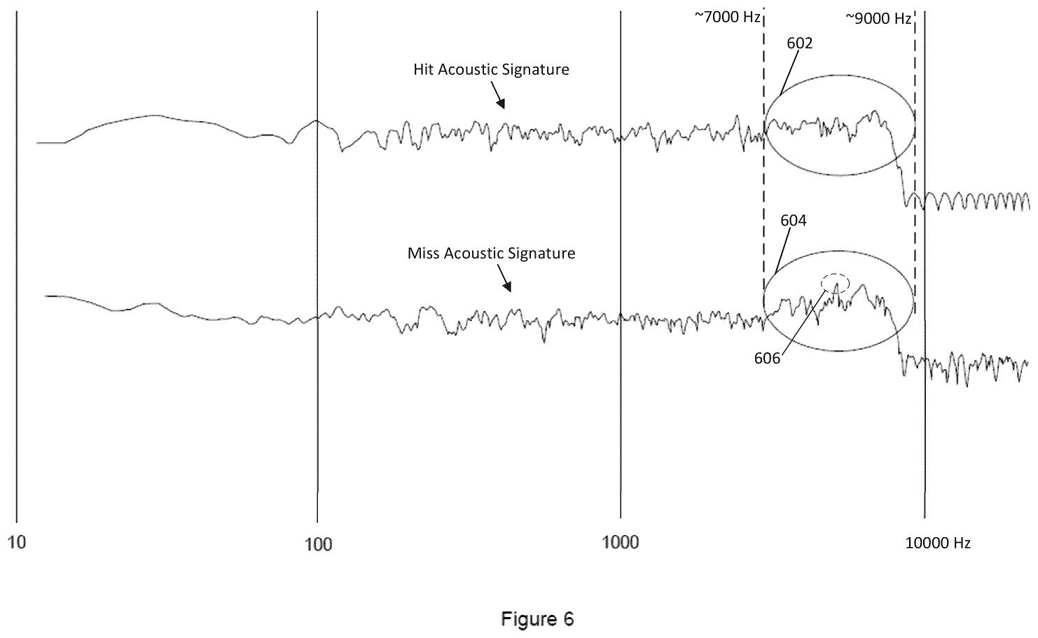

FIG. 6 illustrates a graph showing an acoustic response of a nail gun for a successful and an unsuccessful fastener driving operation, according to some embodiments.

### DETAILED DESCRIPTION

The present disclosure generally relates to systems and methods for improving fastener driving detection operations. In particular, systems, processes and/or techniques are presented that provide for determining the success of a fastener driving operation, and provided a successful faster driving operation, determining a location of the fastener in the material to be fastened.

Powered fastener driving tools, such as nail-driving tools, are widely deployed in the construction industry. Exemplary powered fastener driving tools can use compressed air, gas combustion, explosive powder cartridges, electromagnetic energy, among other power sources, to drive fasteners into a material such as a workpiece. In some examples, powered fastener driving tools can include a nail-driving tools. As used herein, the powered fastener driving tools can be referred to as nail-driving tools.

Nail-driving tools utilizes a power source to drive a nail from a stored source, such as a magazine, into a workpiece, such as through drywall and into a framing stud. The nail-driving tool typically include a housing, which holds the power source; a handle, including a trigger, for use by workmen; a nail magazine holding mechanism; and an actuating mechanism such as a piston, plunger, which drives a nail from the magazine into the workpiece upon the user pressing the trigger. Nail-driving tools typically include various safety features that disable the actuating mechanism unless the tool is firmly pressed against a workpiece.

A long-standing challenge in carpentry, whether using a nail-driving tool or a simple hammer, is to hit the targeted stud, joist, or other framing member with a driven nail. Covering materials typically nailed to studs and joists, such as plywood, drywall, sheathing, are opaque, and the precise location of underlying framing studs are typically approximated. Even after these materials are successfully attached, overlying material, such as flooring, shingles, or siding material additionally require ascertaining the location of underlying studs or joists.

Manual methods for placing and determining the placement of a nail to a stud, joist, or other framing member can be used, but are typically imprecise. For example, walls, floors, roofs, among other building features, are framed using standardized stud or joist spacing, such as being centered approximately every 16 inches. In this case, a user may measure from a reference, such as a corner, or a nail previously (e.g., successfully) driven into an adjacent stud or joist. However, both the manual placement of framing members, and the manual measurements to locate them, can include errors, and can cause a driven nail to “miss” the intended framing member. Once two points of a framing member are successfully located, a chalk line may be placed on the covering to be attached, and nails driven on the chalk line. However, framing members made of natural wood are often bowed, and may deviate from the straight chalk line.

Other devices for determining the location of studs can be impractical to use. In some examples, such devices can project energy, e.g., ultrasonic waves, through a covering to be attached, and measure an intensity of reflected energy while the device is moved over the covering. The same device can indicate areas of high density, since those areas can generate a stronger reflection. The other devices can provide an indication of the location of an underlying stud or joist to a user by illuminating LEDs. However, using such devices to perform a separate stud finding operation prior to driving every nail can be time-consuming, and can interrupt a user's workflow. In one example, a user may not be able to see the display panel of the separate tool easily, and the need for a separate tool can add clutter to the user's toolkit.

In some embodiments, detection systems can be incorporated into nail-driving tools to provide nail driving result detection. In some examples, the detection systems can provide a user with an indication whether a nail was seated into a stud or joist, or if the nail pierced the covering material or overlay, but missed the stud or joist. In some examples, a control system can be used to provide immediate feedback to a user, e.g., such as by illuminating a red or green LED, to indicate success or failure of driving the nail. The detection systems can be used to provide feedback to users so that the users can quickly re-apply another nail.

Detection systems can include detectors that make use of an actuation mechanism of the nail-driving tool. For example, detection systems can use accelerometers to measure the g-force generated during the nail driving operation. In one example, detector systems can use sensors that determine distances along a path of travel of an actuating mechanism to monitor how quickly the actuating mechanism travels, and determine based on this information, whether the nail hit or missed a stud or joist. The detection systems described above can be incorporated and/or combined with the systems and methods described herein.

In contrast to the systems and methods described herein, conventional detection systems and devices can be incompatible with some nail-driving tools (e.g., based on an actuator type used by the detection device). In some examples, some conventional detection systems may not compatible for retrofit with older nail-driving tools. Conventional detection systems can also add to the cost and complexity of the nail-driving tool. Additionally, conventional detection systems can often depend on the actuation mechanism of the nail-driving tool itself. Therefore, it can be beneficial to provide for a built-in robust, practical, and ruggedized fastener driving operation detection methods and systems. In some examples, these systems and methods can be configured to withstand repeated, and/or violent shock from nail driving actuation.

### Fastener Driving Operation Detection Systems and Methods

A fastener driving operation detection system and method is presented, according to some embodiments. In some embodiments, the system can include a discrete fastener driving operation detection system that acoustically determines whether a fastener driving operation was successful or unsuccessful. In some examples, a fastener driving operation can include a fastener driving tool attempting to drive a fastener through an overlying covering material and into an underlying framing member. The success of the fastener driving operation, can include the fastener making contact with and/or hitting the underlying framing member, to secure, bond or fasten the covering material to the underlying framing member. The unsuccessful fastener driving operation can include the fastener missing the underlying framing member. In some examples, a sound generated by a fastener driving operation can be different for a hit, e.g., successful operation, as compared to a miss, e.g., an unsuccessful operation, where the difference may be detected by analyzing an acoustic spectrum of the generated sound of the fastener operation. The acoustic spectrum can be used to make a determination whether the fastener operation was successful or unsuccessful. As described herein, fastener driving operation detection system can also be referred to as a fastener driving system, among other terms.

Referring to FIG. 1, a perspective view of a fastener driving operation detection system is shown, according to some embodiments. In some embodiments, the system 10 can be implemented as a discrete device, according to some embodiments. The system 10 can include a housing 12, sensor 14, and outputs 16, 18 such as light emitting diodes (LEDs). In some embodiments, the sensor 14 can be configured to detect a driving the fastener through a covering material. In some embodiments, the sensor 14 can include and/or be referred to as an acoustic transducer 14 such as a microphone. In some examples, the sensor 14 can include accelerometers, among other sensors. The accelerometers can be used to measure the g-force generated during the nail driving operation. In one example, the sensors can be used to determine distances along the a path of travel of the an actuating mechanism of the nail driving operation to monitor how quickly the actuating mechanism travels, and determine based on this information, whether the nail hit or missed a stud or joist. In one non-limiting example, the sensor 14 can represent more than one sensors. For example, the sensor 14 can include an acoustic transducer, and/or an accelerometer, among other sensors. In some examples, the outputs 16, 18 can include visual indicators, e.g., LEDs. The LEDs can include various LEDs for indicating feedback to a user, e.g., the system 10 can include red LEDs, green LEDs, among other LEDs. In some examples, the system 10 can be configured to provide a user with an indication whether a fastener driving operation is successful or unsuccessful. In one example, a red LED 16 can be illuminated (e.g., turned on, flashed) by the system 10 to indicate an unsuccessful operation (e.g., a miss), and a green LED 18 can be illuminated (e.g., turned on, flashed) by the system 10 to indicate a successful operation (e.g., a hit). The system 10 can also include an audio output (e.g., not shown) that can be used to emit a sound to indicate a successful operation, to indicate a successful operation, or used with different tones or sounds for each detected outcome. The system 10 can include additional features, e.g., such as an external power port or socket, a clamp, magnetic mounting feature, among other features. In some examples, the system 10 can include a battery and electronic circuits. For example purposes, sensor 14 will be described thereafter in the context of an acoustic based sensor (e.g., acoustic transducer 14). Based on the disclosure herein, accelerometers, among other sensors, as discussed above, can also be used, or any combination of acoustic transducers, accelerometers, and/or other sensors, without limitation.

Referring to FIG. 2, a block diagram of circuitry for the fastener driving operation detection system is shown, according to some embodiments. In some embodiments, the circuitry 21 can include the microphone 14, Analog-to-Digital Converter (ADC) 20, processing circuitry 22 implementing a domain transformation module 24 which can include a Discrete Fourier Transform (DFT) function, classifier function 26, and output such as the LEDs 16, 18. The circuitry 21 can optionally include memory 28. The memory 28 can be used to store digitized signals, e.g., digitized acoustic signals, provide program storage, scratch memory, among other functions, for the processor 22. Alternatively, the processor 22 can include built-in memory and/or internal memory such that the memory 28 may not be used. In some examples, the microphone 14 can include an acoustic transducer configured to capture and/or convert sound generated by a fastener driving tool and/or a fastener driving operation into an electronic signal. The sound can include audio and/or captured audio of the fastener driving tool and/or a fastener driving operation. In one example, the ADC 20 can include an ADC having sufficient processing speed to convert an analog audio signal of up to approximately 20 KHz.

Referring again to FIG. 2, in some embodiments, the processing circuitry 22 can include processing circuitry configured to generate a signal based on the detected driving of a fastener through the covering material. The processing circuity 22 can be configured to analyze a frequency spectrum of the signal to generate a frequency spectrum analysis. Based on the frequency spectrum analysis, the processing circuity 22 can be configured to determine whether the fastener hit or missed the underlying framing member, and generate an indication of the determination. In some examples, the processing circuitry can be configured to generate a signal based on a measured g-force. The processing circuitry can be configured to analyze a frequency spectrum of the signal to generate a frequency spectrum analysis. Based on the frequency spectrum analysis, the processing circuitry can be configured to determine whether the fastener hit or missed the underlying framing member, and generate an indication of the determination.

Referring again to FIG. 2, the processing circuitry 22 can be used to analyze and/or classify the captured audio, according to some embodiments. In some embodiments, the processing circuitry 22 analyze a frequency spectrum of the captured audio to generate a frequency spectrum analysis. Based on the frequency spectrum analysis, the processing circuitry 22 can provide a determination of one of two outcomes: a successful operation, e.g., a hit, or an unsuccessful operation, e.g., a miss. To facilitate the analysis of the frequency spectrum, the processing circuitry 22 can implement a transformation of the captured audio signal from the time domain to the frequency domain, e.g., to generate a frequency domain representation. As depicted in FIG. 2, this may be performed by executing, for example, a Discrete Fourier Transform (DFT) 24. In some examples, other domain transformation algorithms can be used, such as a Discrete Cosine Transform (DCT), Modified DCT (MDCT), Discrete Sine Transform (DST), Fast Fourier Transform (FFT), among others. The domain transformation module 24 can be implemented as a software module. In some examples, the domain transformation module 24 can alternatively and/or additionally include hardware acceleration features.

In some examples, the domain transformation module 24 can output the audio spectrum of the captured audio signal to the classifier function 26. The classifier function 26 can analyze the frequency domain representation of the audio. In some examples, the classifier function 26 can analyze at least one predetermined frequency range of the audio spectrum (e.g., which may include the entire spectrum), and based on the analysis, the classifier function 26 can classify the fastener driving operation as a hit or a miss. The classifier function 26 may perform this classification in several ways.

In some embodiments, the classifier 26 can analyze, classify and/or identify a captured audio signal at a first frequency, or in a first frequency range, associated with a successful or unsuccessful fastener driving operation. In some examples, the classifier function 26 can compare the magnitude, e.g., within the frequency domain, of the captured audio signal in a first predetermined frequency range to a first predetermined threshold. If the captured audio signal exceeds the first threshold anywhere within this first predetermined frequency range, the classifier function 26 can make a determination that the driven fastener hit an underlying framing member, e.g., determining that a successful operation has occurred. The classifier can subsequently provide the result, e.g., being a successful driving operation, to the output function 16, 18. In one example, upon making a determination of a successful operation, the processing circuitry 22 may cause the green LED 18 to illuminate for a predetermined duration. Alternatively, if the magnitude, e.g., within the frequency domain, of the captured audio signal in the first predetermined frequency range is less than the first threshold, the classifier function 26 can make a determination that the driven fastener missed the underlying framing member, e.g., determining that an unsuccessful operation occurred. The classifier can subsequently provide the result, e.g., being an unsuccessful driving operation, to the output function 16, 18. In one example, upon making a determination of an unsuccessful operation, the processing circuitry 22 may cause the red LED 16 to illuminate for a predetermined duration.

In some embodiments, the classifier 26 can analyze, classify and/or identify the captured audio signal at a second frequency, or in a second frequency range, associated with an unsuccessful fastener driving operation. In some examples, the classifier 26 can identify a captured audio signal at a second frequency, or in a second frequency range, associated with a fastener driving miss. In this example, the classifier function 26 can compare the magnitude, e.g., within the frequency domain, of the captured audio signal in the second predetermined frequency range to a second predetermined threshold. In one example, the second threshold can be the same as the first threshold. If the captured audio signal exceeds the second threshold anywhere within the second predetermined frequency range, the classifier function 26 make a determination that the driven fastener missed an underlying framing member, e.g., determining that an unsuccessful operation occurred. The classifier can subsequently provide the result, e.g., being an unsuccessful driving operation, to the output function 16, 18.

In some embodiments, the classifier function 26 can use both the first threshold for the first frequency range and the second threshold for the second frequency range to make an improved determination whether the fastener driving operation is successful or unsuccessful. In some examples, the classifier function 26 can use both the first threshold for the first frequency range and the second threshold for the second frequency range to verify the determination of the fastener driving operation is successful or unsuccessful. Using both the first threshold for the first frequency range and the second threshold for the second frequency range can allow for the classifier function 26 to provide for an improved classification confidence for the determined result. In some examples, the classifier function 26 can make a determination whether the frequency domain captured audio signal both exceeds the first predetermined threshold in the first predetermined frequency range, and is less than the second predetermined threshold in the second predetermined frequency range, and based on that determination, the classifier function 26 can classify the fastener driving operation as a hit. Similarly, the classifier function 26 can make a determination that the frequency domain captured audio signal both exceeds the second predetermined threshold in the second predetermined frequency range, and is less than the first predetermined threshold in the first predetermined frequency range, and based on that determination, the classifier function 26 can classify the fastener driving operation as a miss.

In some embodiments, thresholds for particular frequency ranges can be stored, and the stored thresholds for the particular frequency ranges can be compared to the frequency domain captured audio signal to make a determination whether the fastener driving operation is successful or unsuccessful. In some examples, stored threshold can be used to classify different sizes of fasteners, lengths of fasteners, different covering materials, different types of wood in underlying framing members, different frequency ranges, among others. The stored threshold can be used to associate particular sound characteristics to a hit and/or miss result. The classifier function 26 can compare the magnitude of the frequency domain captured audio signal to different stored threshold over particular frequency ranges, and classify the fastener driving operation as a hit or miss, depending on the frequency ranges for which the signal exceeds an associated threshold. In one example, characteristic hit and miss frequency ranges can be used for one or more combinations of fasteners and materials. To achieve an improved classification confidence, once a frequency domain captured audio signal is determined to exceed a threshold for a frequency range associated with a hit, the same frequency domain captured audio signal can be analyzed to determine if it additionally exceeds another threshold corresponding to a frequency range associated with a miss, for the same fastener driving conditions.

In some embodiments, a calibration procedure can be used to calibrate the classifier function 26 to a particular combination of fastener driving tools, covering materials, underlying framing members, and/or acoustic environments. In some examples, upon power-on, or upon selection of calibration via a switch (not shown in FIG. 1), the fastener driving operation detection system 10 can initiate a calibration procedure. In one example, to calibrate a miss or an unsuccessful operation, the system 10 can initiate and/or flash the red LED 16, indicating that the user can drive a fastener to intentionally miss any underlying framing member, and subsequently the system 10 can capture, digitize, and/or store an associated audio signal for the miss. To calibrate a hit or a successful operation, the system 10 can initiate and/or flash the green LED 18, indicating that the user can drive a fastener to hit an underlying framing member, and subsequently the system 10 can capture, digitize, and/or store the associated audio signal for the hit. Both the miss and hit acoustic signals can be transformed to the frequency domain, and analyzed for characteristic miss and hit acoustic signatures. Based on these acoustic signatures, the hit and/or miss frequency ranges can be determined, and associated threshold calculated and stored. In subsequent operation under the same fastener driving conditions, these frequency ranges and associated thresholds can be utilized, as described above, to classify the results of fastener driving operations.

In some embodiments, the classifier function 26 can include a Machine Learning (ML) model trained on acoustic signatures corresponding to fastener driving operations. The ML model can be trained to distinguish the audio of fastener driving operations that hit an underlying framing member from the audio of fastener driving operations that miss the underlying framing member. In some examples, one or more fastener driving operations (e.g., hundreds of fastener driving operations) can be used to train the ML model. The ML model can take an entire acoustic spectrum of the captured audio as input, and can output a hit or miss determination based on a comparison to the trained model. Numerous types of ML algorithms may be used. Because the classifier function 26 can classify all captured acoustic signals into two classes, a variety of ML algorithms can be used and/or can be uniquely suited to the task of distinguishing the audio of fastener hitting or missing the underlying framing member. Some example ML algorithms can include a two-class support vector machine, a two-class perceptron, a two-class decision forest, a two-class logistic regression, a two-class boosted decision tree, and a two-class neural network. One advantage to using a ML model is that the training data can include a large variety of fastener driving tools, fasteners, covering materials, and/or underlying framing members. Accordingly, the same ML model can be used to classify hit or miss outcomes for fastener driving operations regardless of the fastener driving conditions.

Regarding to FIG. 3, a flowchart for a method of determining a result of a fastener driving operation is presented, according to some embodiments. In a step 102, the method can include capturing audio generated by an operation of a fastener driving tool attempting to drive a fastener through a covering material and into an underlying framing member. In a step 104, the method can include analyzing at least a portion of a frequency spectrum of the captured audio. In a step 106, a determination whether the driven fastener hit or missed the underlying framing member can be performed based on the frequency spectrum analysis at step 104. If the determination is a miss, an indication of a miss is generated at step 108. If the determination is a hit, an indication of a hit is generated at step 110. The indication of a miss or hit can be subsequently output to a user, such as by illuminating an LED. In some examples, the indication of a miss or hit can be out to a user by illuminating a red LED 116 or green LED 18, respectively. Alternatively, the indication may be transmitted to another computer or system.

The discrete fastener driving operation detection system 10, can provide one or more advantages. In some embodiments, the system 10 can be configured to include a small and/or lightweight configuration, and can be inexpensive to produce. The system 10 can be compatible with and/or be used with any type of fastener driving tool. In some examples, the system 10 can be compatible with and/or be used with legacy fastener driving tools, to provide automated confirmation of fastener driving operations. The system 10 can operate on a job site at which numerous fastener driving tools are utilized. As described herein, embodiments of the fastener driving operation detection system 10 are not limited to the system 10 described in FIG. 1.

Referring to FIG. 4, a nail-driving tool 30 which incorporates a fastener driving operation detection system is shown, according to some embodiments. In some embodiments, the nail-driving tool 30 can include a housing 32, nosepiece 34, handle 36 with trigger 38, and nail magazine 39. The nail-driving tool 30 can be powered by compressed air, gas combustion, explosive cartridge, electric or electromagnetic drivers, among others.

In some embodiments, a fastener driving operation detection system can be incorporated into the nail-driving tool 30. A microphone 14, located near the nosepiece 34, can capture sound generated by a nail driving operation. The circuitry of FIG. 2 can be implemented in a ruggedized configuration, and incorporated within the housing 32 of the nail-driving tool 30. Outputs, such as a red miss LED 16 and green hit LED 18 with the nail-driving tool 30, and can be included in a location visible to an operator during use. The fastener driving operation detection system can operate as described herein, providing a confirmation of the results of each nail-driving operation to the user of the nail-driving tool 30.

Referring to FIG. 5, a nail-driving tool adapted as an end effector of an industrial robot 40 is shown, according to some embodiments. The robot 40 comprises a multi-axis robotic arm 42, and any of a variety of robotic interface modules 44, such as a robotic tool changer, a force/torque sensor, or the like. The nail-driving tool 46 can operate similarly to the nail-driving tool 30 of FIG. 3, driving nails from a magazine 48 into workpieces, under the control of a robotic control system of the robotic nail-driving tool 46. The robotic nail-driving tool 46 can include at least some components of the fastener driving operation detection system. In some examples, an acoustic transducer 14 such as a microphone shown in FIG. 1, can be disposed on the robotic nail-driving tool 46, positioned so as to capture sound from a nail-driving operation. In some examples, output signals can be sent to a robotic control program from the robotic nail-driving tool 46, the signals can be used to verify the results of fastener driving operations. In some examples, the processing circuitry 22 of FIG. 2 can include one of more processors of the robotic control system of the robotic nail-driving tool 46, whereby the output of the classifier function 26 can be immediately available to other modules of the robotic control system. In one example, such a configuration can allow the robotic nail-driving tool 46 to proceed with another fastener driving operation, or to interrupt the robotic nail-driving tools 46 planned motion to re-drive a fastener in the event of a detected miss.

FIG. 6 shows representative acoustic signatures for fastener driving operations, according to some embodiments. A representative acoustic signature for a successful fastener driving operation, e.g., labeled as a hit acoustic signature is shown. An unsuccessful fastener driving operation, labeled as a miss acoustic signature is also shown. In some embodiments, each of the acoustic signatures can be obtained by analyzing a frequency spectrum. A portion of each acoustic signature, e.g., within a range of approximately 7,000-9,000 Hz (e.g., frequency spectrum), is labeled at 602 for the hit acoustic signature, and at 604 for the miss acoustic signature for comparison. Due to the forces involved in performing a successful driving operation (e.g., described herein as a “hit” or “hit fastener driving operation”), as compared to an unsuccessful driving operation (e.g., described herein as a “miss” or “missed fastener driving operation”), the sound and/or acoustic frequencies of the hit and miss can vary. Upon a successful driving operation, a nail will hit a stud behind the sheathing of a wood member, and the nail will be constrained by the wood member that surrounds it. For such a successful driving operation, the portion 602 of the hit acoustic signature can be used for comparison. For an unsuccessful driving operation, when the nail misses the stud, a component of the nail gun that extends to push the nail into the wood member, referred to as a hammer, can extend to its maximum length since the nail did not encounter the wood member. The extension of the hammer can cause vibrations throughout the nail gun. These vibrations can result in substantially increased amplitudes, referred to herein as peak amplitudes. An exemplary peak amplitude 606 is shown, within the portion 604 of the miss acoustic signature. For the example shown in FIG. 6, the difference between the peak amplitude 606 with respect to the amplitudes of the frequencies shown within the portion 602 for the hit operation can be used to determine a difference between the hit and the miss acoustic signatures. In some embodiments, the difference can include a difference in magnitude between the peak amplitude 606 with respect to thresholds associated with (e.g., within) a frequency range. Thus, a difference between one or more peak amplitudes for a miss in comparison to amplitudes for a hit can be used to determine a difference between a hit and a miss for one or more fastener driving operations.

Embodiments of the present invention present numerous advantages over the prior art. Detecting the result of a fastener driving operation acoustically makes such detection independent of the fastener driving means. A discrete fastener driving operation result detection device offers the advantages of being usable with any fastener driving tool, and can operate on multiple faster driving tools. The fastener driving operation detection system can be incorporated into a fastener driving hand tool, or a robotic fastener driving tool.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A fastener driving system, the system comprising:
a fastener driving tool configured to drive a fastener through a covering material and into an underlying framing member;
a sensor comprising at least one of an acoustic transducer or an accelerometer, wherein the sensor is configured to detect the driving of the fastener through the covering material; and
processing circuitry configured to:
generate a signal based on the detected driving of the fastener through the covering material;
analyze a frequency spectrum of the signal to generate a frequency spectrum analysis;
based on the frequency spectrum analysis, determine whether the fastener hit or missed the underlying framing member; and
generate an indication of the determination.

2. The system of claim 1, wherein provided the sensor is the accelerometer, the accelerometer is configured to measure a g-force generated by the fastener driving tool; and
the processing circuitry is configured to:
generate a signal based on the measured g-force;
analyze a frequency spectrum of the signal to generate a frequency spectrum analysis;
based on the frequency spectrum analysis, determine whether the fastener hit or missed the underlying framing member; and
generate an indication of the determination.

3. The system of claim 1, wherein provided the sensor is the acoustic transducer, the acoustic transducer is configured to capture a sound generated by the fastener driving tool; and
the processing circuitry is configured to:
generate an audio signal based on the captured sound;
analyze a frequency spectrum of the audio signal to generate a frequency spectrum analysis;
based on the frequency spectrum analysis, determine whether the fastener hit or missed the underlying framing member; and
generate an indication of the determination.

4. A fastener driving system, the system comprising:
a fastener driving tool configured to drive a fastener through a covering material and into an underlying framing member, wherein the fastener tool generates sound upon driving the fastener through the covering material;
an acoustic transducer configured to capture the sound generated by the fastener driving tool; and
processing circuitry configured to:
generate an audio signal based on the captured sound;
analyze a frequency spectrum of the audio signal to generate a frequency spectrum analysis;
based on the frequency spectrum analysis, determine whether the fastener hit or missed the underlying framing member; and
generate an indication of the determination.

5. The system of claim 4, further comprising outputs configured to convey the fastener driving operation result detection to a user based on the determination.

6. The system of claim 5, wherein the outputs comprise visual indicators.

7. The system of claim 4, wherein the acoustic transducer comprises a microphone.

8. The system of claim 4, wherein analyzing the frequency spectrum comprises:
transforming the audio signal to an audio signal having a frequency domain representation; and
analyzing the frequency domain representation of the audio signal.

9. The system of claim 8, wherein analyzing the frequency domain representation of the audio signal comprises:
comparing a magnitude of the audio signal to a first predetermined threshold associated with a first frequency range; and
determining a result of the fastener operation based on whether the magnitude of audio signal exceeds the first threshold within the first frequency range.

10. The method of claim 9, wherein analyzing the frequency domain representation of the audio signal comprises:
comparing the magnitude of the audio signal to a second predetermined threshold associated with a second frequency range; and
verifying the determined result of the fastener operation based on whether the magnitude of the audio signal exceeds the second threshold within the second frequency range.

11. The system of claim 8 wherein analyzing the frequency domain representation of the audio signal comprises:
processing the audio signal with a Machine Learning (ML) model, wherein the ML model was trained to distinguish the audio of fastener driving operations that hit an underlying framing member from the audio of fastener driving operations that miss the underlying framing member.

12. A method of determining a result of a fastener driving operation, the method comprising:
capturing sound generated by operation of a fastener driving tool attempting to drive a fastener through a covering material and into an underlying framing member;
generating an audio signal based on the captured sound;
analyzing at least a portion of a frequency spectrum of the audio signal to generate a frequency spectrum analysis;
based on the frequency spectrum analysis, determining whether the driven fastener hit or missed the underlying framing member; and
generating an indication of the determination.

13. The method of claim 12 further comprising outputting the indication of the determination to a user.

14. The method of claim 12 further comprising transmitting the indication of the determination to a robotic control system.

15. The method of claim 13 wherein analyzing at least a portion of a frequency spectrum of the audio signal comprises:
transforming the audio signal to a frequency domain; and
analyzing the frequency domain representation of the audio signal.

16. The method of claim 15 wherein analyzing the frequency domain representation of the audio signal comprises:
comparing a magnitude of the audio signal to a first predetermined threshold associated with a first frequency range; and
determining a result of the fastener operation to be the hit or miss associated with the first frequency range if the magnitude of the audio signal exceeds the first threshold within the first frequency range.

17. The method of claim 16 wherein analyzing the frequency domain representation of the audio signal comprises:
comparing a magnitude of the audio signal to a second predetermined threshold associated with a second frequency range; and
verifying the determined result of the fastener operation if the magnitude of the audio signal exceeds the second threshold within the second frequency range.

18. The method of claim 15 wherein analyzing the frequency domain representation of the audio signal comprises:
processing the audio signal with a Machine Learning (ML) model, wherein the ML model was trained to distinguish the audio of fastener driving operations that hit an underlying framing member from the audio of fastener driving operations that miss the underlying framing member.

19. A computer implemented method for determining a result of a fastener driving operation, the method comprising:
capturing sound generated by operation of a fastener driving tool attempting to drive a fastener through a covering material and into an underlying framing member;
generating an audio signal based on the captured sound;
comparing at least a portion of a frequency spectrum of the audio signal to a stored threshold frequency;
based on the frequency spectrum comparison, determining whether the driven fastener hit or missed the underlying framing member; and
generating an indication of the determination.

20. The method of claim 19 further comprising outputting the indication of the determination to a user.

21. The method of claim 19 further comprising transmitting the indication of the determination to a robotic control system.

22. The method of claim 19 wherein comparing at least a portion of a frequency spectrum of the audio signal to a stored threshold frequency comprises:
transforming the audio signal to a frequency domain; and
analyzing a frequency domain representation of the audio signal.

23. The method of claim 22 wherein analyzing the frequency domain representation of the audio signal comprises comparing a magnitude of the audio signal to a stored threshold frequency associated with a first frequency range.
